(19) United States
(12) Patent Application Publication
(10) Pub. No.: US 2006/0172739 A1
(43) Pub. Date: Aug. 3, 2006

(54) Avoidance of overload in SHO

(75) Inventors: Jeroen Wigard, Klarup (DK); Juha Pirskanen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/325,237

(22) Filed: Jan. 3, 2006

Related U.S. Application Data
(60) Provisional application No. 60/641,189, filed on Jan. 3, 2005.

(51) Int. Cl. H04Q 7/20

(52) U.S. Cl. 455/442

(57) ABSTRACT

To prevent oscillation of the load on a radio interface between a user equipment device and a base station of a non-serving cell scheduled in a decentralized way by a base station of a serving cell, a centralized control action is performed by a radio network controller to reduce load congestion on the radio interface in the non-serving cell. Oscillation in load might otherwise exist over the radio interface due to the decentralized scheduling trying to maintain a high degree of load in all cells combined with independent control action by the non-serving cell to reduce the load congestion.

### CROSS-REFERENCE TO RELATED APPLICATION

Priority is claimed from U.S. Provisional Application 60/641,189 filed Jan. 3, 2005.

### BACKGROUND OF THE INVENTION

1. Technical Field

The field of the invention is mobile communications and, more particularly, to management of inter-cell interference in relation to de-centralized scheduling.

2. Discussion of Related Art

The invention relates to the 3GPP (Third Generation Partnership Project) specification of the Universal Mobile Telecommunications System (UMTS) Terrestrial Radio Access (UTRA) and more specifically to the Wideband Code Division Multiple Access (WCDMA) High Speed Uplink Packet Access (HSUPA) which is an enhanced uplink feature used in the Frequency Division Duplex (FDD) mode. This feature is being specified in the 3GPP and targeted to 3GPP release 6.

Referring to FIG. 1, the Universal Mobile Telecommunications System (UMTS) packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network over a (wired) Iu interface.

FIG. 2 shows some further details of the architecture, particularly the UTRAN. The UTRAN includes multiple Radio Network Subsystems (RNSs), each of which contains at least one Radio Network Controller (RNC). Each RNC may be connected to multiple Node Bs which are the 3GPP counterparts to GSM base stations. Each Node B may be in radio contact with multiple UEs via the radio interface (Uu) shown in FIG. 1. A given UE may be in radio contact with multiple Node Bs even if one or more of the Node Bs are connected to different RNCs. For instance a UE1 in FIG. 2 may be in radio contact with Node B 2 of RNS 1 and Node B 3 of RNS 2 where Node B 2 and Node B 3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. One of the RNCs will act as the “serving” or “controlling” RNC (SRNC or CRNC) while the other will act as a “drift” RNC (DRNC). A chain of such drift RNCs can even be established to extend from a given SRNC. The multiple Node Bs will typically be neighboring Node Bs in the sense that each will be in control of neighboring cells. The mobile UEs are able to traverse the neighboring cells without having to re-establish a connection with a new Node B because either the Node Bs are connected to a same RNC or, if they are connected to different RNCs, the RNCs are connected to each other. During such movements of a UE, it is sometimes required that radio links be added and abandoned so that the UE can always maintain at least one radio link to the UTRAN. This is called soft-handover (SHO).

With the introduction of HSUPA the packet scheduler is moved from the RNC to the Node B. Due to the decentralization, the possibility arises to more quickly react to overload situations, enabling much more aggressive scheduling, e.g., by faster modifications of the bit rates, which will give a higher cell capacity. HSUPA and the fast Node B controlled scheduling are also supported in soft handover.

According to Section 7.1 of the Technical Specification 3GPP TR 25.896 v6.0.0 (2004-03) entitled “Feasibility Study for Enhanced Uplink for UTRA FDD (Release 6),” the term “Node B scheduling” denotes the possibility for the Node B to control, within the limits set by the RNC, the set of Transport Format Combinations (TFCs) from which the UE may choose a suitable TFC. A Transport Format Combination is the combination of currently valid Transport Formats on all Transport Channels of a UE, i.e., containing one Transport Format from each Transport Channel (see 3G TS 25.302 for related definitions and in-depth explanations). In Release 5, the uplink scheduling and rate control resides in the RNC. According further to the TR 25.896 specification, by providing the Node B with this capability, tighter control of the uplink interference is possible which, in turn, may result in increased capacity and improved coverage. The TR 25.896 specification discusses two fundamental approaches to scheduling: (1) rate scheduling, where all uplink transmissions occur in parallel but at a low enough rate such that the desired noise rise at the Node B is not exceeded, and (2) time scheduling, where theoretically only a subset of the UEs that have traffic to send are allowed to transmit at a given time, again such that the desired total noise rise at the Node B is not exceeded.

Since the HSUPA scheduling is decentralized, each Node B schedules without knowing what the other Node Bs are doing. Still, decisions done in one cell affect to the neighboring cells because of the phenomenon called “other cell interference.” Furthermore, in soft handover, only one Node B may be delivering scheduling commands leading to increased transmission data rate (seen as higher transmission power) to the UE that is actually in connection to multiple Node Bs.

For a connection in SHO in HSUPA, one of the cells in SHO is the serving cell and this cell determines the Enhanced DCH (E-DCH) bit rate, i.e. performs the HSUPA scheduling. See Section 9 (Node B controlled scheduling) of 3GPP TS 25.309 v6.1.0 (2004-12) FDD Enhanced Uplink for current thinking in standardization (3GPP TSG-RAN2) where it is proposed that the other cells can give an overload indication by sending a DOWN command to the UE, which should lead to the UE lowering its bit rate. The serving cell does not however know why the UE has lowered its bit rate. It could be that the UE has hit maximum power or it could be that the UE has no more data in its buffer. The UE in its turn may ask for a higher bit rate again, leading to a higher scheduled bit rate from the serving cell. This again causes overload in one of the cells in the active set (set of radio links simultaneously involved in a specific communication service between a UE and a UTRAN access point). In other words, oscillations are likely to occur in such a scenario. A problem is likely to occur when the uplink load between two cells are not close to equal and the scheduling cell is in a lower load situation, performing a scheduling decision so that a UE in an SHO situation with equal link qualities (or if link quality of non-serving cell is better) increases the transmission bit rate, creating an overload situation in the non serving E-DCH cell.

The problem will be less likely, or even nonexistent, if the cell loads of both cells participating in SHO are equal, and/or the link quality of the serving cell is better, as the serving cell's decision will not cause overload in its own cell and the fast power control will drive the transmission powers based on best link requirements.

### DISCLOSURE OF INVENTION

An object of the present invention is to provide a general solution to the above described overload problem that can be applied to that situation and to similar overload problem situations.

The idea is to solve the HSUPA SHO issue in the RNC. The RNC should monitor the UEs active on the E-DCH and determine which are in SHO. The RNC needs to find among those UEs the ones for which one of the non-serving cells in the active set is close to congestion (from a power and/or hardware point of view). Then it can consider one (or both) of the following actions:
When including the new cell to the active set of the UE, restrict the maximum bitrate of low priority connections.
Lower the maximum bitrate of those UEs (UEs in SHO having serving cell in low load and diversity branch in high load), such that the overload situation disappears. In this case oscillations no longer happen since the maximum bitrate can not be changed by any Node B.
Change the serving cell to the cell with the high load, immediately in active set update or after receiving measurement reports from a UE (1D “change of best cell”) and Node B (Total received uplink power). In that case the high load situation is automatically taken care of. This should only be done for those cases where the highly loaded cell is the best or close to be the best cell in the active set of the UE.

The possible short term overload will be automatically handled in Node B, as the Node B would lower the bitrates of the UEs whose scheduling cell it is. The consequence of this is that the received power from UEs in SHO would be considered as non-controlled load, which would then be adjusted by the above actions by the RNC. However, as this non-controlled load is contributing to the SHO of the UE, the total system throughput is not reduced.

Advantages:

allows the RNC to have some centralized control over the decentralized schedulers that may be adversely impacting each other and oscillations are avoided.
the UE has to receive one or more channels less (the channels on which the DOWN command potentially is sent), i.e., no need for a UE to listen to the relative grant channel from all cells in the active set.
the available noise rise after the scheduling decision is utilized by the UE in the serving E-DCH cell as instructed by the Node B scheduler. Thus, there will be no under-utilized air interface resources.
simpler Node B scheduler.
yet another advantage that can help the situation is that the serving Node B would be informed when a UE goes into SHO, i.e. is notified when the active set of a UE becomes larger than one.
   Disadvantages:
Introducing some control from the RNC slows down the HSUPA. However, the optimum behavior is that network load is balanced between different cells, and the RNC control will drive cells to be more equally balanced.

It should be realized that although the present specification discloses the invention in the context of an improvement to an HSUPA situation, it should be realized that the core concept is applicable to other situations in wireless interfaces and not limited to HSUPA and not limited to the uplink direction.

### BRIEF DESCRIPTION OF THE DRAWING

FIG. 1 shows the packet network architecture for the Universal Mobile Telecommunications System (UMTS).

FIG. 2 shows some further details of the overall architecture of the UMTS.

FIG. 3 illustrates an embodiment of a system including a combination of devices acting cooperatively to carry out the invention.

FIG. 4 shows a centralized control action carried out according to the present invention.

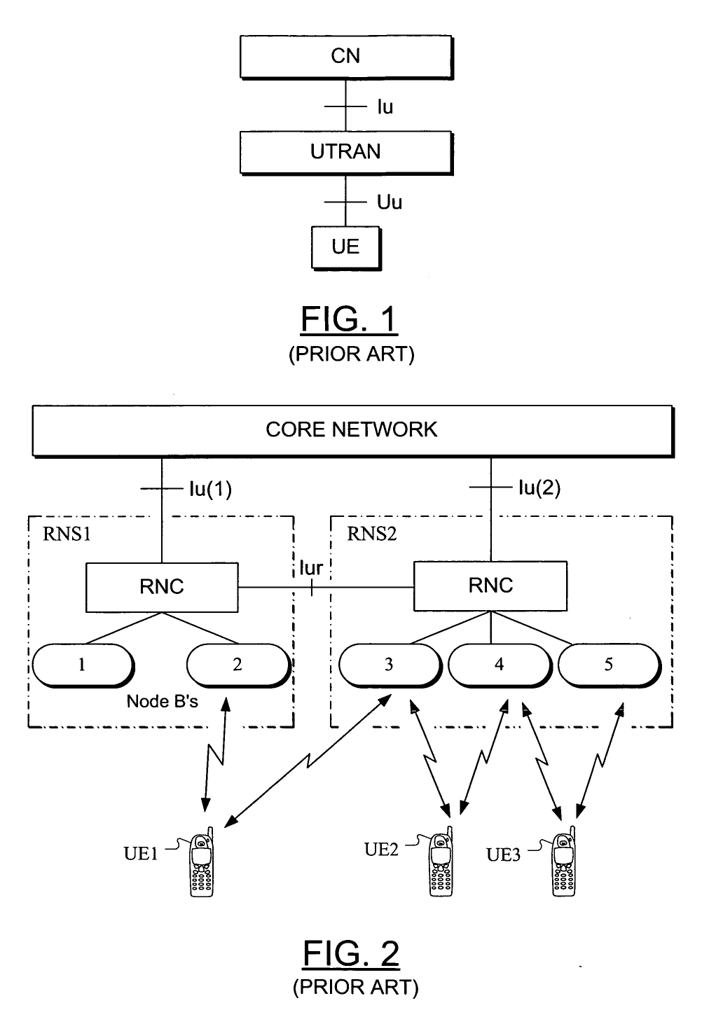

### BEST MODE FOR CARRYING OUT THE INVENTION

As mentioned above, in HSUPA the scheduling is done from one cell (serving E-DCH cell), but this cell is unaware of the SHO status of a UE. Overload in non-serving cells can be avoided by sending DOWN commands to the UE, including those in SHO. As also mentioned above, this can lead to oscillations and require that the UE listen to the relative grant channel (the channel on which the DOWN command is sent). Moreover, in a case where the link quality toward the serving E-DCH cell is significantly better than toward the non-serving cell, if a mechanism to avoid oscillation is introduced (filters into UE to send grant request again) the cell throughput of the scheduling cell is not as fully utilized as it otherwise would be since it will take some time for the scheduling cell to notice that the UE is not using all interference resources that the scheduler was allocating for it. In other words, the scheduler will detect that the noise rise of the cell is less than was expected and that it should perform a new scheduling decision to assign the available noise rise to some other UE.

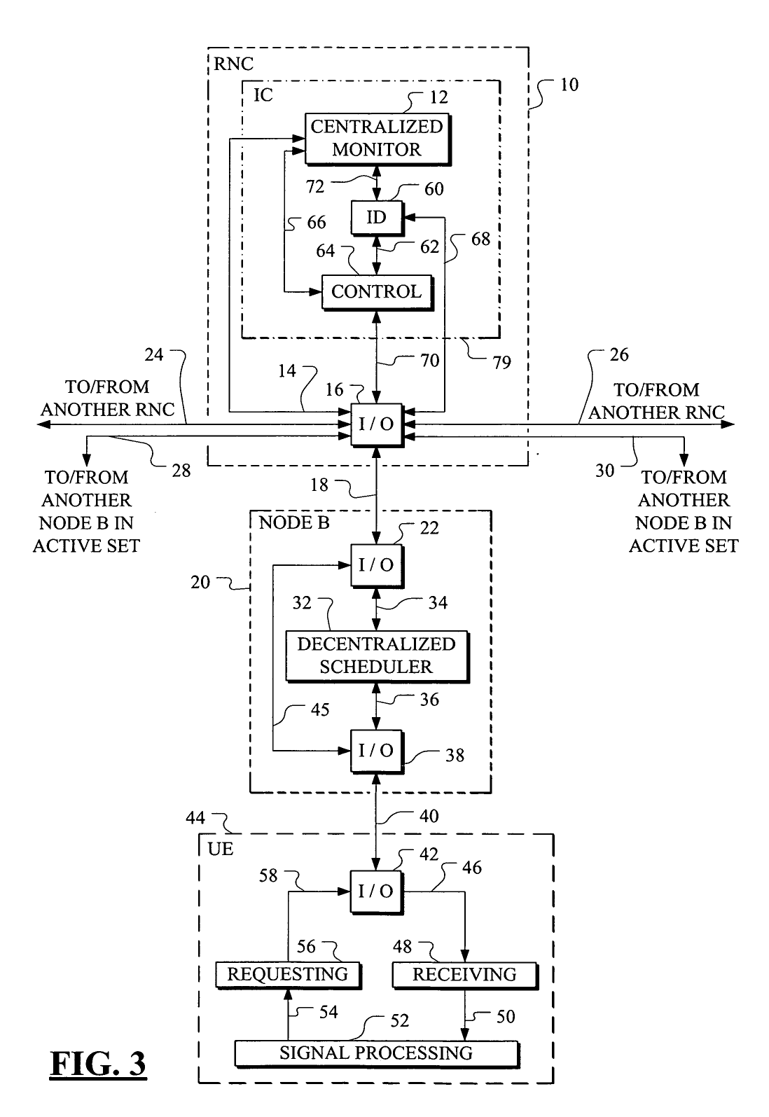

Therefore, according to the present invention, an HSUPA SHO issue such as described above can be solved by using the RNC to monitor the UEs active on the E-DCH and determine which are in SHO. FIG. 3 shows an RNC 10 having a centralized monitor 12 therein which is able to determine which UEs active on the E-DCH are in SHO. It is connected by a signal on a line 14 to an input/output device 16 within the RNC which in turn is connected by means of an interface 18 to a Node B 20. The Node B also has an input/output device 22 which allows the RNC to access information about the UEs active on the E-DCH that are in SHO. Also shown in FIG. 3 is a signal line 24 connecting the RNC 10 to another RNC over a so-called Iur interface and a similar signal line 26 between the input/output device 16 and yet another RNC. Each of these RNCs can be connected to one or more Node Bs of their own and the RNC 10 is similarly shown connected to a plurality of Node Bs via the input/output device 16 and signal lines 28 and 30. The RNC 10 therefore will have access to multiple Node Bs including those in an active set of a UE (an active set is the set of radio links simultaneously involved in a specific communication service between a UE and a UTRAN access point). One of the Node B's in the active set serves as the so-called “serving cell” and it does the scheduling for so long as it remains the serving cell.

The Node B 20, as mentioned above, has been given the task of scheduling and performs the function in a decentralized manner as indicated by a decentralized scheduler 32 shown within the Node B 20 and connected by a signal on a line 34 to the input/output device 22 interfacing with the RNC 10. The decentralized scheduler 32 communicates its scheduling instructions by a signal on a line 36 to an input/output device 38 interfacing over a radio interface 40 to an input/output device 42 of a user equipment 44. The RNC 10 may also communicate directly with the user equipment as shown by a signal on a line 45 between the input/output devices 22, 28.

The input/output device 42 communicates scheduling instructions with a signal on a line 46 to a device 48 for receiving signalling information from the Node B. The receiving device 48 processes the received signalling and provides a processed signal on a line 50 to a signal processor 52 which uses the scheduling instructions at an RRC layer to control the data rate of the uplink communication or the time of transmission or both. The signal processor 52 provides the communication or signalling or both on a line 54 to a transmitting/requesting device 56 for, among other things, acknowledging instructions received from the RRC layer of the RNC, for transmitting payload, for requesting modifications to the capacity of the radio link 40, etc. The device 56 provides a signal on a line 58 to the input/output device 42 of the UE 44 which signalling is provided on the radio link 40 back to the Node B 20 where it is received by the input/output device 38 of the Node B and subsequently communicated on the signal line 36 to the decentralized scheduler 32, to the RNC, or to some other functional entity in the Node B or RNC.

Referring back to the RNC 10, in the context of the present invention, the centralized monitor will monitor the Node B 20 as well as other Node Bs in the active set of the UE 44. The RNC may be connected on the signal lines 28, 30 to neighboring Node Bs which may be in the active set. On the other hand, the UE may have associated with its active set Node Bs connected to other RNCs which would be communicated with by the RNC 10 over the signal lines 24 or 26 or both. In any event, the RNC 10 will use the centralized monitor 12 to monitor user equipment active on a dedicated channel and in soft handover between both a serving cell and one or more non-serving cells with the serving cell performing the decentralized scheduling for both the serving cell and for the one or more non-serving cells. In the context of the situation shown in FIG. 3, the Node B 20 can be considered to be the Node B in the serving cell. Other Node Bs active in the UE's 44 active set will be the non-serving cells whether they be connected to RNC 10 or to other RNCs connected to RNC 10 over Iur interfaces 24, 26.

The RNC also includes a device 60 that is used to identify, also in a centralized manner, a non-serving cell having a radio link with the user equipment 44 and currently experiencing load congestion over the link. The identification device 60 is shown connected by a signal on a line 62 to a control device 64 within the RNC 10. The control device 64 is also connected by a signal on a line 66 to the centralized monitor 12 for control thereof. The identification device 60 is shown connected by a signal on a line 68 to the input/output device 16 of the RNC so that it is able to gather the information concerning cells having radio links with the user equipment 44 that are experiencing load congestion over such a link. This information may be gathered from NBAP Common Measurement Reports from the base stations (Node B's) in the active set. It does this under the control of the control device 64 which is also shown connected by a signal on a line 70 to the input/output device 16 of the RNC 10. The identification device 60 may also be connected by a signal on a line 72 to the centralized monitor 12 in order to request and receive information concerning which UEs are in SHO.

Once the identification device 60 identifies a non-serving cell having a radio link with the UE 44 that is experiencing load congestion over the link between the non-serving cell and the UE 44, the control device 64 receives this information from the identification device 60 on the signal line 62 and performs a centralized control action to reduce the load congestion. This has the effect of preventing oscillation in load that otherwise would exist over the congested link between the user equipment 44 and the Node B of the non-serving cell due to the decentralized scheduling performed in the Node B 20 (in the serving cell) combined with independent control actions of the non-serving cell to reduce the load congestion between itself and the user equipment 44.

The centralized monitor 12, the identification device 60 and the control device 64 may be individually embodied in separate integrated circuits or one or more of the devices 12, 60, 64 may be combined into an integrated circuit. Or, the functions carried out by these devices can be embodied in coded instructions stored on a memory device for execution by a signal processor. Likewise, a combination of hardware and coded instructions can be used in a manner selected by the designer for optimizing resources as desired by a particular application. Similarly, the decentralized scheduler 32 of the Node B 20 may be embodied in software, hardware or a combination thereof. Thus, the functional block 32 could be an integrated circuit or a series of coded instructions stored on a computer readable medium for execution by a signal processor. Similarly, the signal processing unit 52 of the user equipment 44 could be embodied in some combination of software and hardware as will be appreciated from the foregoing including but not limited to an integrated circuit.

One of the control actions that the control device 64 may carry out is lowering a maximum bitrate for some selected links or for all links.

Another of the control actions that the control device 64 may carry out is to restrict the maximum bit rate of low priority connections when including a new cell in the active set of the UE 44.

Still another possible control action would be to lower the maximum bit rate of those UEs in SHO having serving cell in low load and diversity branch in high load, such that the overload situation disappears. In this case, oscillations no longer happen since the maximum bit rate cannot be changed by any Node B.

Yet another possible control action that may be carried out by the control device 64 is changing the serving cell to a cell with a relatively high load only if the cell with the relatively high load has a link with relatively strong signal strength.

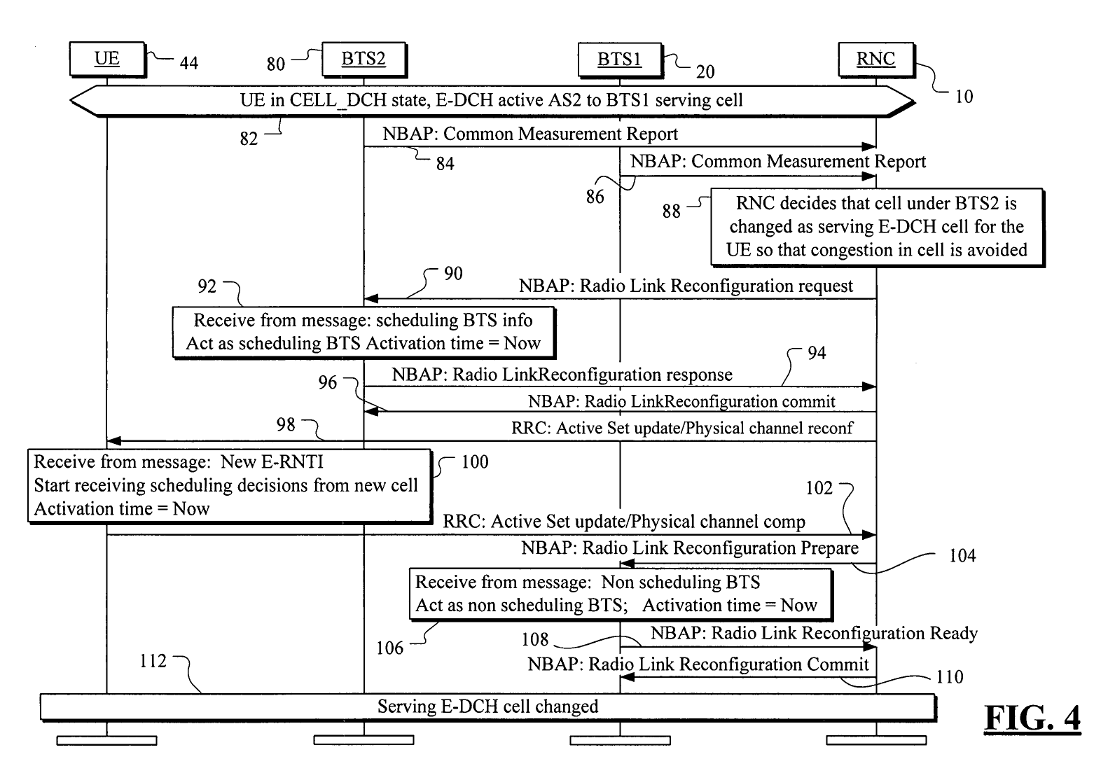

For instance, as shown in FIG. 4, it is assumed that the user equipment 44 of FIG. 3 is in the CELL_DCH state, with the E-DCH active in an active set including two base stations (Node Bs) 20, 80 as shown in FIG. 4 with base station 20 being in the serving cell. This state of affairs is signified by a block 82 in FIG. 4 spanning the UE 44, the non-serving cell 80, the serving cell 20 and the radio network controller 10. In this scenario, the base stations 80, 20 will send Common Measurement Reports from the Node B application part (NBAP) as shown by signal reports 84, 86 from the base stations 80, 22 to the RNC 10. The centralized monitor 12 of FIG. 3 is able to process information contained in these reports and the identification device 60 is able to use this processed information for the purposes described previously.

In this case, it is determined by the control 64 of the RNC 10 to change the serving cell from the current serving cell 20 to the current non-serving cell 80 as shown in a block 88. The RNC 10 sends an NBAP Radio Link Reconfiguration request as shown by a signal on a line 90 from the RNC 10 to the current non-serving cell 80. A block 92 shows the current non-serving cell 80 receiving the NBAP message on the line 90 from the RNC 10 and receiving centralized scheduling information from the RNC, and changing itself over by activating itself to become the serving base station providing decentralized scheduling. It signals an NBAP Radio Link Reconfiguration response on a signal line 94 to the RNC 10. The RNC responds with an NBAP Radio Link Reconfiguration Commit on a line 96 back to the now serving base station 80. At this point the formerly serving base station 20 is now a non-serving base station. The RNC 10 also sends an RRC active set update signal on a line 98 directly to the user equipment via the serving base station. In a block 100, the user equipment 44 is shown receiving the active set update signal from the RNC and setting a new E-RNTI (radio network temporary identity) and starts receiving scheduling decisions from the new serving cell 80. The user equipment 44 sends an RRC Active Set updates/Physical channel comp signal on a line 102 back to the RNC 10 and the RNC 10 in turn sends an NBAP Radio Link Reconfiguration Prepare signal on a line 104 to the former serving base station 20 which receives the message, as indicated in a block 106, and processes the information that it is now the non-scheduling base station and commences to act as the non-scheduling base station. It signifies its receipt of the instructions with an NBAP Radio Link Reconfiguration Ready Signal on a line 108 to the RNC 10 which in turn responds with a NBAP Radio Link Reconfiguration Commit signal on a line 110 back to the now non-serving cell 20. As signified by a block 112, spanning the UE 44, the new serving cell 80, the former serving cell 20 and the RNC 10, the serving E-DCH cell has now been changed to a cell with a relatively high load in a case where the cell has a link with the UE having a relatively strong signal strength.

Although the invention has been shown and described with respect to a best mode embodiment thereof, it will be evident to those of skill in the art that various other devices and methods can be provided to carry out the objectives of the present invention while still falling within the coverage of the appended claims.

1. Method, comprising:
monitoring, in a centralized manner, user equipment in soft handover between both a serving cell and one or more non-serving cells with the serving cell performing decentralized scheduling for both the serving cell and for the one or more non-serving cells,
identifying, in said centralized manner, a non-serving cell having a radio link with said user equipment and experiencing load congestion over said link, and
performing a centralized control action to reduce said load congestion so as to prevent oscillation in load otherwise existing over said link due to said decentralized scheduling combined with independent control actions of said non-serving cell to reduce said load congestion.

2. The method of claim 1, wherein said monitoring, identifying, and performing a centralized control action is for execution by a radio network controller of a radio access network and said decentralized scheduling is for execution by a base station of said radio access network.

3. The method of claim 2, wherein said centralized control action comprises restricting a maximum bitrate of links having a priority lesser than that of other links.

4. The method of claim 1, wherein said centralized control action comprises restricting a maximum bitrate of links having a priority lesser than that of other links.

5. The method of claim 2, wherein said centralized control action comprises lowering a maximum bitrate for some or all links.

6. The method of claim 1, wherein said centralized control action comprises lowering a maximum bitrate for some or all links.

7. The method of claim 2, wherein said centralized control action comprises changing the serving cell to a cell with a relatively high load only if the cell with the relatively high load has a link with relatively strong signal strength.

8. The method of claim 1, wherein said centralized control action comprises changing the serving cell to a cell with a relatively high load only if the cell with the relatively high load has a link with relatively strong signal strength.

9. Device, comprising:
a monitor for monitoring, in a centralized manner, user equipment in soft handover between both a serving cell and one or more non-serving cells with the serving cell performing decentralized scheduling for both the serving cell and for the one or more non-serving cells,
an identifier for identifying, in said centralized manner, a non-serving cell having a radio link with said user equipment and experiencing load congestion over said link, and
a control for performing a centralized control action to reduce said load congestion so as to prevent oscillation in load otherwise existing over said link due to said decentralized scheduling combined with independent control actions of said non-serving cell to reduce said load congestion.

10. The device of claim 9, wherein said centralized monitoring, identifying, and performing a control action is for execution by a radio network controller of a radio access network and said decentralized scheduling is for execution by a base station of said radio access network.

11. The device of claim 10, wherein said centralized control action comprises restricting a maximum bitrate of links having a priority lesser than that of other links.

12. The device of claim 9, wherein said centralized control action comprises restricting a maximum bitrate of links having a priority lesser than that of other links.

13. The device of claim 10, wherein said centralized control action comprises lowering a maximum bitrate for some or all links.

14. The device of claim 9, wherein said centralized control action comprises lowering a maximum bitrate for some or all links.

15. The device of claim 10, wherein said centralized control action comprises changing the serving cell to a cell with a relatively high load only if the cell with the relatively high load has a link with relatively strong signal strength.

16. The device of claim 9, wherein said centralized control action comprises changing the serving cell to a cell with a relatively high load only if the cell with the relatively high load has a link with relatively strong signal strength.

17. System, comprising:
(a) a network element (10) comprising:
(i) a monitor for monitoring, in a centralized manner, user equipment in soft handover between both a serving cell and one or more non-serving cells with the serving cell performing decentralized scheduling for both the serving cell and for the one or more non-serving cells;
(ii) an identifier for identifying, in said centralized manner, a non-serving cell having a radio link with said user equipment and experiencing load congestion over said link; and
(iii) a control for performing a centralized control action to reduce said load congestion so as to prevent oscillation in load otherwise existing over said link due to said decentralized scheduling combined with independent control actions of said non-serving cell to reduce said load congestion, and
(b) a base station (20) connected to said network element including a scheduler (32) for providing scheduling signalling in a serving cell among a plurality of cells in an active set, and
(c) user equipment (44) connected to said base station by a radio link (40) for carrying out communications with said base station (20) in said serving cell and other base stations in non-serving cells in said active set.

18. The system of claim 17, wherein said centralized monitoring, identifying, and performing a control action is for execution by a radio network controller of a radio access network and said decentralized scheduling is for execution by said base station of said radio access network.

19. The system of claim 18, wherein said centralized control action comprises restricting a maximum bitrate of links having a priority lesser than that of other links.

20. The system of claim 17, wherein said centralized control action comprises restricting a maximum bitrate of links having a priority lesser than that of other links.

21. The system of claim 18, wherein said centralized control action comprises lowering a maximum bitrate for some or all links.

22. The system of claim 17, wherein said centralized control action comprises lowering a maximum bitrate for some or all links.

23. The system of claim 18, wherein said centralized control action comprises changing the serving cell to a cell with a relatively high load only if the cell with the relatively high load has a link with relatively strong signal strength.

24. The system of claim 17, wherein said centralized control action comprises changing the serving cell to a cell with a relatively high load only if the cell with the relatively high load has a link with relatively strong signal strength.

25. Base station (20), comprising:
a first input/output device (22) for providing to a network element (10) an information signal (18) indicative of user equipment (44) in soft handover between both a serving cell and one or more non-serving cells, said first input/output device responsive to a control signal (18) from said network element (10), for providing a received control signal for reducing load congestion over a radio link in a non-serving cell so as to prevent oscillation in load over said radio link due to said decentralized scheduling combined with independent control actions of said non-serving cell to reduce said load congestion;
a scheduler (32), responsive to said received control signal, for providing a scheduling signal (36) for both the serving cell and for the one or more non-serving cells; and
a second input/output device (38), responsive to said scheduling signal, for transmitting said scheduling signal to said user equipment (44) over a radio interface (40) in said serving cell.

26. User equipment (44), comprising:
a receiver device (48), responsive to a scheduling signal (46) from a base station (20) indicative of transmission characteristic commanded over each of a plurality of radio links established between said user equipment and both a serving cell and at least one non-serving cell, for providing a received scheduling signal (50); and
a signal processor (52), responsive to said received scheduling signal (50), for providing an information signal (54) according to said transmission characteristic wherein said scheduling signal is commanded by said base station in said serving cell and wherein said base station is responsive to a centralized control action carried out by means of signalling from a network element (10) to said base station to prevent oscillation in load otherwise existing over a radio link between said user equipment and one or more of said at least one non-serving cells due to decentralized scheduling by said base station combined with independent control actions of said at least one non-serving cell to reduce said load congestion.

27. Method for execution by a base station (20), comprising:
providing (22) from a first input/output device (22) of said base station to a network element (10) an information signal (18) indicative of user equipment (44) in soft handover between both a serving cell and one or more non-serving cells, said information identifying at least one non-serving cell having a radio link with said user equipment and experiencing load congestion over said link,
receiving at said first input/output device a control signal (18) from said network element (10) for reducing load congestion over said radio link in said at least one non-serving cell so as to prevent oscillation in load over said radio link in said non-serving cell due to decentralized scheduling by said base station combined with independent control actions of said one or more non-serving cells to reduce said load congestion, and
providing said received control signal (34) to a scheduler (32) of said base station, said scheduler for providing in response thereto a scheduling signal (36) for both the serving cell and for the one or more non-serving cells according to said control signal.

28. Method for execution by user equipment (44), comprising:
responding to a scheduling signal (46) from a base station (20) indicative of transmission characteristic commanded over each of a plurality of radio links established between said user equipment and both a serving cell and at least one non-serving cell by providing a received scheduling signal (50), and
responding to said received scheduling signal (50) by providing an output signal (54) according to said transmission characteristic wherein said scheduling signal is commanded by said base station in said serving cell and wherein said base station is responsive to a centralized control action carried out by means of signalling from a network element (10) to said base station to prevent oscillation in load otherwise existing over a congested radio link between said user equipment and one or more of said at least one non-serving cells due to decentralized scheduling by said base station combined with independent control actions of said at least one non-serving cell to reduce load congestion over said congested radio link.

29. Computer program product with executable code stored on a computer readable medium for executing the steps of claim 1.

30. Computer program product with executable code stored on a computer readable medium for executing the steps of claim 27.

31. Computer program product with executable code stored on a computer readable medium for executing the steps of claim 28.

32. An integrated circuit (79) for use in a radio network controller (10) in carrying out the steps of claim 1.

33. An integrated circuit (32) for use in a base station (20) in carrying out the steps of claim 27.

34. An integrated circuit (52) for use in user equipment in carrying out the steps of claim 28.
